(19) United States
(12) Patent Application Publication
(10) Pub. No.: US 2002/0106265 A1
(43) Pub. Date: Aug. 8, 2002

(54) Binding apparatus and method

(76) Inventor: Mario Litsche, Fellbach (DE)

Correspondence Address: Kevin L. Leffel, Heidelberg Digital L.L.C., 2600 Manitou Road, Rochester, NY, 14624, US

(21) Appl. No.: 09/994,742

(22) Filed: Nov. 28, 2001

(30) Foreign Application Priority Data
Nov. 13, 2001 (EP) 01126528.7
Nov. 29, 2000 (DE) 10059344.5
Aug. 27, 2001 (DE) 10141811.6

(51) Int. Cl. B42B 5/10

(52) U.S. Cl. 412/39

(57) ABSTRACT

The invention relates to a device for binding brochures, and is in the field of apparatus and processes for binding brochures with wire binding elements having variable characteristics, and for making such elements. According to various aspects of the invention, apparatus and methods are provided for making wire binding elements with variable characteristics.

### BACKGROUND

The invention relates to a device for binding brochures, and is in the field of apparatus and processes for binding brochures with wire binding elements having variable characteristics, and for making such elements.

In certain prior art binding processes, wire binding elements are produced and subsequently used in binding devices for loose binding of a brochure consisting of several sheets of printed material. One type of wire binding element is a wire comb binding, for example the Wire-O® binding.

Wire-O® binding elements comprise parallel separated wire loops with a loop length L, a loop spacing A and a wire diameter D and are formed into a ring using appropriate closing devices.

The wire binding elements are generally made available in magazines for such binding devices, in order to take into account different requirements in binding, like thickness and format of the brochures using the loop spacing, the loop length, etc. Devices that produce the wire binding elements with different parameters like loop spacing, loop length and number of loops belong to the state of the art. To date, however, changing the parameters has required considerable intervention and reconfiguration of the device for producing the wire binding elements.

A method is known from DE 28 47 700 A1 for producing a wire binding for note pads, etc., in which a wire that is continuously pulled from a wire supply is shaped into a wave pattern by bending it back and forth, and whereby the wave-shaped wire pattern is then bent into a C-shape perpendicular to the plane of the waves. Forming rollers with set diameters are used for bending so that only wire binding elements with unchangeable loop spacings and lengths are produced.

Binding devices for producing brochures, which use Wire-O™ binding elements in various sizes are known, e.g. from the European patent applications EP 0 095 243 and EP 0 095 245. Also, there is an overview of different binding methods in H. Kipphan “Handbuch der Printmedien [Print Media Manual]”, Pages 861 and following; Springer Verlag (2000).

The binding devices for the aforementioned patent applications are designed in such a way that it is possible to produce formed binding elements with various loop spacings and lengths.

In general, the named devices have the disadvantage that in order to bind brochures with different formats and thickness, the wire binding elements required for this have to be made available to the binding device in the form of several different supplies of binding elements that are already preformed, e.g. as binding elements wound on spools or elements cut to the binding length. A considerable number of supplies are needed in order to be able to bind the various brochure formats and thickness. In addition, in order to change the format of the brochures to be produced, the transport and processing equipment must be adapted to the requirements of the different wire binding elements. This conversion requires costly designs of the transport and binding equipment, and therefore the binding process only becomes cost effective if a larger number of brochures are produced in one format. Smaller production runs are therefore not cost-effective and require large amounts of time to adjust the machinery.

Because of the possibilities permitted by modern digital printing, the requirement for and the possibility of producing personalized books or books with very small print run has increased, in the extreme case with a print run of one copy, sometimes referred to as “book-on-demand.”

Devices for producing such personalized books or individual print runs is known from U.S. Pat. No. 5,465,212 and is also illustrated in H. Kipphan “Handbuch der Printmedien [Print Media Manual]”, Pages 989, 999 and following; Springer Verlag (2000). Especially for this type of small print runs, it is necessary to be able to bind the books reliably and in a cost-effective way.

### SUMMARY OF THE INVENTION

According to various aspects of the invention, apparatus and methods are provided for making wire binding elements with variable characteristics.

### BRIEF DESCRIPTION OF THE DRAWINGS

FIG. 1 presents a perspective view of a device according to one aspect of the invention.

FIG. 2 presents a wire binding element that may be made according to an aspect of the invention.

FIG. 3 presents an embodiment of a brochure bound with a single wire binding element, according to an aspect of the invention.

FIG. 4 presents an embodiment of a brochure bound by means of several single wire binding elements, according to a further aspect of the invention.

FIG. 5 presents an embodiment of a brochure bound by a plurality of single wire binding elements arranged at a distance from each other, according to a further aspect of the invention.

FIG. 6 presents a schematic representation of a wire supply with different wire supply rolls, according to a further aspect of the invention.

FIG. 7 presents a schematic representation of a wire bending device comprising racks and pinions, according to a further aspect of the invention.

FIG. 8 presents a schematic representation of a wire bending device with a rocker on the first and second sleds, according to a further aspect of the invention.

FIG. 9 presents a schematic representation of a wire bending device comprising an arm connecting a bending die rod in neutral position, according to a further aspect of the invention.

FIG. 10 presents a schematic representation of a wire bending device comprising an arm connecting a bending die rod in 45° working position, according to a further aspect of the invention.

FIG. 11 presents a schematic representation of a wire bending device comprising an arm connecting a bending die rod in an end position, according to a further aspect of the invention.

FIG. 12 presents a schematic side view of a bending die rod with the cover not shown and the spring housing cut away, according to a further aspect of the invention.

FIG. 13 presents a schematic side view of the front side of a cutting device and fixed second collet with the cover not shown in wire direction, according to a further aspect of the invention.

FIG. 14 presents a schematic side view of the reverse side of a cutting device and a fixed second collet with the cover not shown, according to a further aspect of the invention.

### DETAILED DESCRIPTION

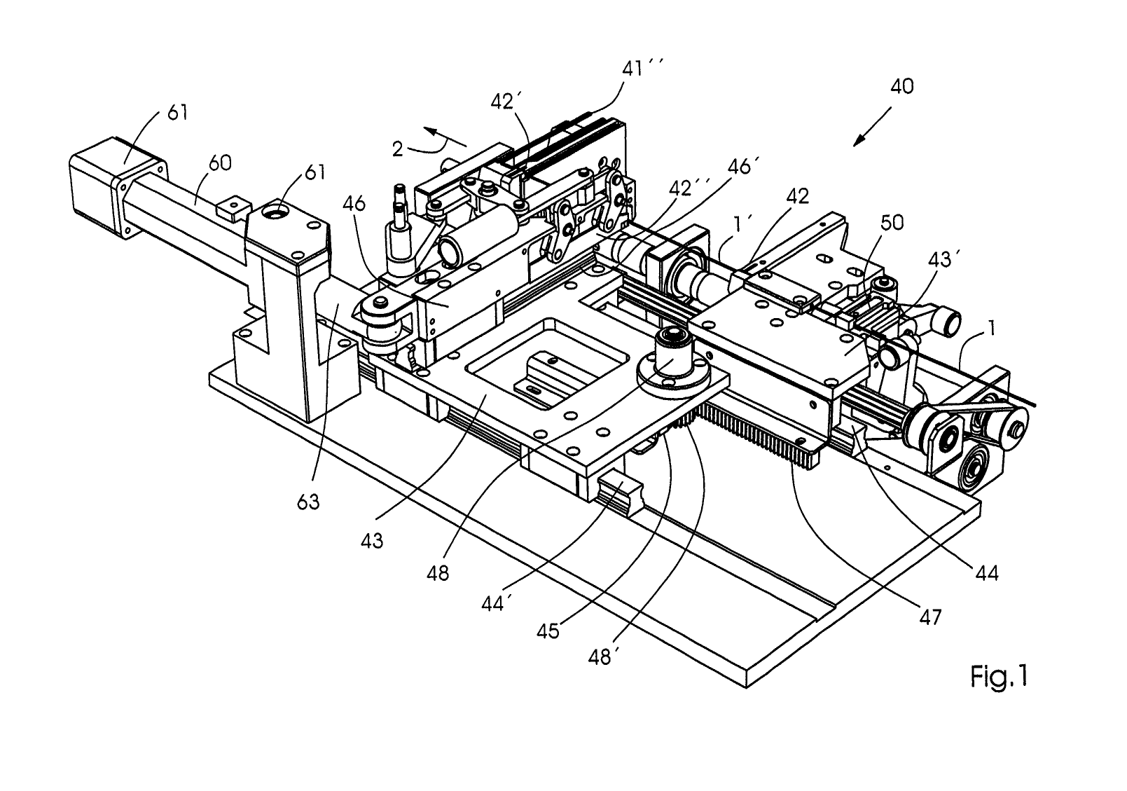

Various aspects of the invention are presented in FIGS. 1-14, which are not drawn to scale and wherein like components in the numerous views are numbered alike. It is not intended to limit the invention according to a specific embodiment presented herein, as the various features may be interchanged, combined, or modified, without departing from the invention. All such embodiments are considered to fall within the purview of the invention as defined by the claims appended hereto. In some instances, particular mechanical components may not be described in great detail since suitable structure is evident from the mechanical arts. The apparatus and processes disclosed herein are particularly useful for flexible production of wire binding elements. The binding elements produced according to the invention may be implemented for various binding uses, including binding brochures of any format and thickness.

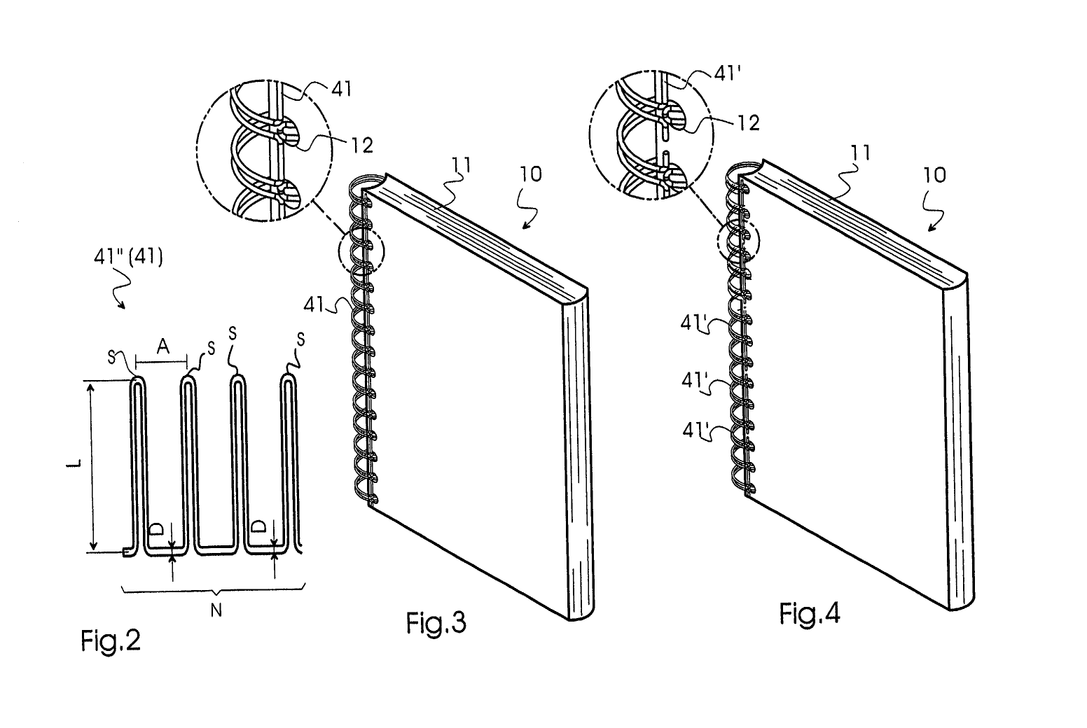

Referring now to FIGS. 2-5, wire binding elements 41, 41′, 41″, are presented according various aspects of the invention. As presented in FIG. 2, a wire binding element 41″ (41) comprises loops S with a loop length L, a loop spacing A, a wire diameter D and a number of loops N.

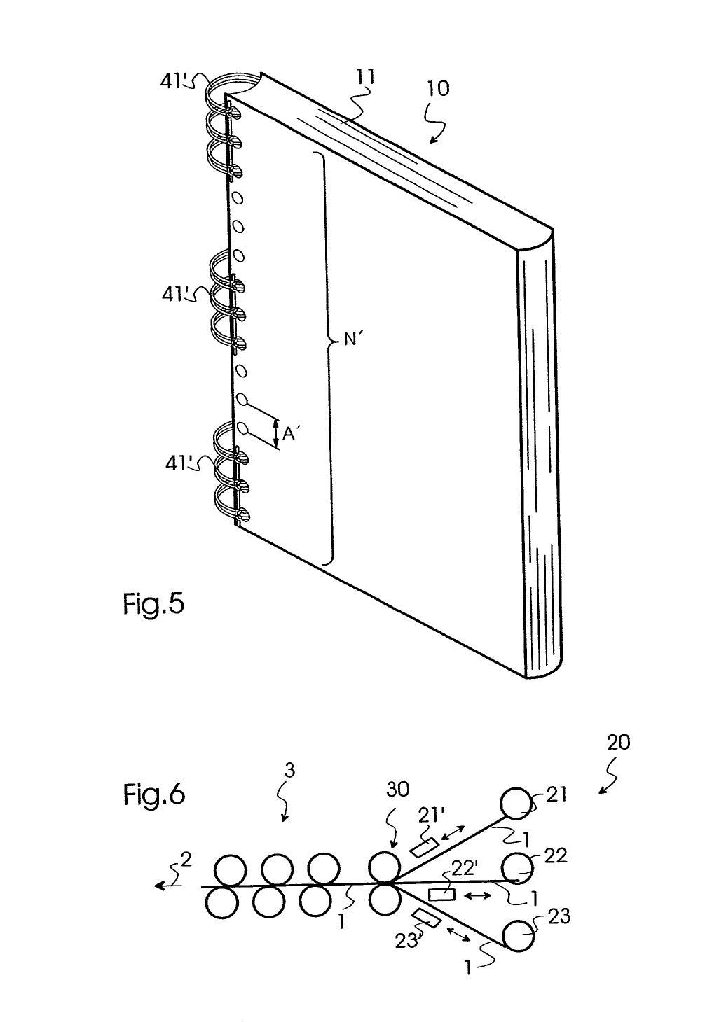

In FIG. 3, a brochure 10 is shown that has been finished bound with a continuous binding. FIG. 4 shows an individual binding that consists of wire binding elements 41′, which have only a single loop respectively, and for each hole 12 in the stocks exactly one wire binding element 41′ is used. FIG. 5 shows a wire comb binding that consists of several, e.g. multi-loop wire binding elements 41′ that are spaced from one another such that holes 12 remain free. Every other combination of the options mentioned above is evident from the description provided herein, and any such variations are considered to fall within the purview of the invention.

Referring now to FIG. 6, a wire supply 20 is presented, according to a further aspect of the invention, equipped with wire supply rolls 21, 22 and 23. Each wire provided by the supply rolls 21, 22, and 23 may have the same or different characteristics, such as wire diameter, color, composition, etc., without limitation. Wire diameter is preferably within a range of 0.8 mm to 1.2 mm, although the invention is not so limited. Different color codes and can be assigned to the previously mentioned wire diameters. One, two, three, or more supply rolls or spools may be provided in the practice of the invention.

One or more supply rolls 21, 22, 23 may be provided with a gripper 21′, 22′, 23′ assigned to a corresponding supply roll. The wire supply ends can be transported from the individual wire supply rolls 21 to 23 to a transport device 30 that may comprise a transport roller pair of the type known in the mechanical arts. For mechanical wire tension relief and/or wire straightening, three additional transport roller pairs 3 may be provided, which are mounted downstream in the transport direction and whose transport rollers are mounted slightly offset to one another. It is within the scope of the invention that instead of three wire supply rolls, only one wire supply roll 22 with a wire diameter of preferably 1 mm may be used for all the brochure formats to be bound.

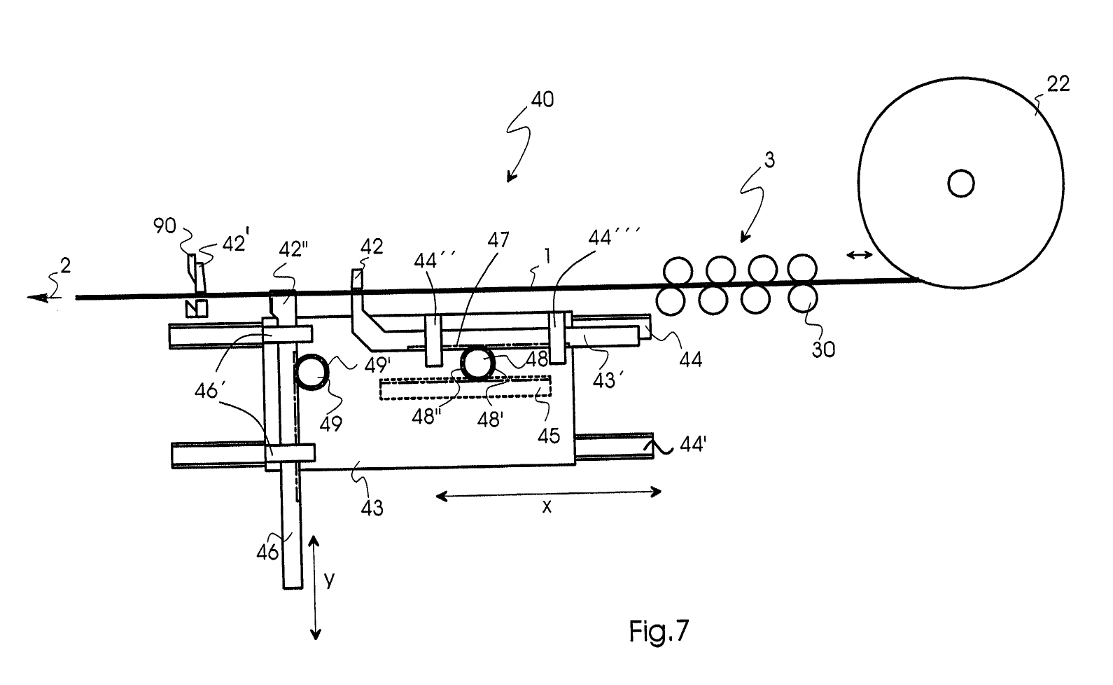

According to a further aspect of the invention, apparatus for producing a wire binding element are provided. The apparatus comprises a mechanism having a set of connected components. A dimension of a loop for at least one of the brochures may be varied by varying the mechanism with one of the connected components. The components may be connected directly, or by one or more intervening components. Referring now to FIG. 7, one example of such an apparatus 40 is presented comprising a first sled 43 that moves back and forth along the wire transport path 2, referred to herein as the first or X direction. Two guides 44, 44′ may be provided in the housing of the device, on which the first sled 43 is mounted so that it can slide along wire direction 2.

A second sled 43′ is also provided mounted so that it can slide by means of at least one guide 44″, 44″ mounted on the first sled 43, for movement of the second sled 43′ parallel to the wire direction 2. Also, a bending die rod 46 is mounted on the first sled 43 by means of a guide 46′ in such a way that a rectilinear movement of the bending die rod 46 is carried out, preferably perpendicular to the wire direction 2, referred to herein as the second or Y direction. The bending die rod 46 comprises a bending die 42″. The first and second directions are transverse to each other, preferably forming a right angle, although the invention is not so limited.

The second slide 43′ bears a first collet 42, with which the wire 1 can be clamped. A second collet 42′ is provided mounted to the housing of device 40, with which the wire 1 can be clamped. The second sled 43′ may also carry a feeder collet, not shown in FIG. 7, a suitable structure being presented in FIG. 1 (feeder collet 50). The feeder collet preferably operates independently of the first collet 42. The collets disclosed herein are opened and closed by suitable apparatus known in the mechanical arts, including a cam control and an electromagnet, without so limiting the invention.

Still referring to FIG. 7, a rack 45 is provided mounted in a fixed location on the housing of the device 40. The second sled 43′ is provided with a rack 47. A shaft 48 is mounted in the first sled 43. A pair of pinions 48′ and 48″ are mounted to the shaft 48, preferably having the same effective diameter, one of pinions 48′ and 48″ engaging the rack 45, and another of the pinions 48′ and 48″ engaging the rack 47. Rotating the shaft 48 drives the pinions 48′ and 48″ which, in turn, drive the racks 45 and 47, thereby translating the first sled 43 and second sled 43′ in the X direction. This arrangement causes the second sled 43′ to move twice as far as the first sled 43 (as is evident from FIG. 7, the first sled 43 moves with the shaft 48 mounted thereto proportional to the effective radius of the pinion, and the second sled 43′ moves proportional to the effective diameter of the pinion). The shaft 48 may be driven by a motor. According to a preferred embodiment, the motor is a stepper motor. Numerous variations are evident, one being that a single pinion 48′ could engage both racks 45, 47, all such variations falling within the purview of the invention.

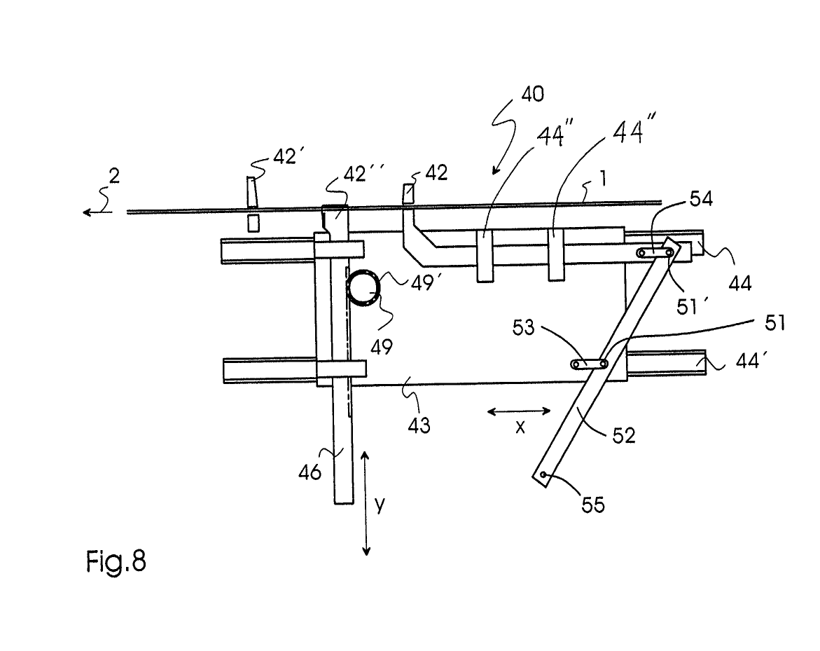

Referring now to FIG. 8 an alternative embodiment of device 40 is presented for carrying out coupled movement of the sleds 43 and 43′. At a fixed point of rotation 55, a rocker 52 is mounted so that it can rotate. The rocker 52 may be mounted, so that it can rotate, on a mounting point 51 on the first sled by way of a coupling 53 and at a second mounting point 51′ on the second sled 43′ by way of a coupling 54. In this process, the distance from the point of rotation 55 to mounting point 51 is essentially the same as the distance between the mounting points 51, 51′ of the couplings 53, 54 on the first sled 43 and the second sled 43′. As the first sled 43 is moved, the second sled is moved exactly twice the distance along the guides 44″, 44′″ by way of couplings 53, 54 and the rocker 52.

The movement of the various components described herein is determined by the dimensions of the wire binding element being produced. Referring to FIGS. 2,7 and 8 the movement of the bending die 42″ (mounted to the first sled 43) in the Y direction corresponds to the width L of the loop S, and the movement of the collet 42 (mounted to the second sled 43′) corresponds to twice the width L of the loop S. According to a preferred embodiment, the movement of the bending die 42″ and the collet 42 are sinusoidal. The sled 43 carrying the bending die rod 46 and the bending die 42″ in a sinusoidal movement in the X direction, and the bending die rod 46 carrying the bending die 42″ in a complementary sinusoidal movement in the Y, such that the tip of the bending die 42″ that contacts the wire 1 moves essentially through a 90° arc about the collet 42′. The collet 42 follows along with an X direction displacement twice the sled 43 displacement. A stepper motor may be used to implement the sinusoidal movement. For example, a stepper motor may be implemented to drive a shaft 49 having a pinion 49′ mounted thereto that engages a rack on the bending die rod 46, to move the bending die 46 with a sinusoidal Y motion that complements a sinusoidal X motion of the sled 43.

A preferred, alternative embodiment of apparatus 40 is presented in FIGS. 1 and 9 to 12. This embodiment is similar to that previously described with reference to FIGS. 7 and 8, except the first slide 43 and the second slide 43′ are separately mounted on guides 44 and 44′. A single pinion (not shown because it is disposed beneath the sled 43) engaging racks 45 and rack 47 drives slide 43′ relative to slide 43 with the motion previously described herein, wherein the second slide 43′ moves twice as far relative to the first slide 43.

The embodiment of FIGS. 1 and 9 to 12 is further characterized by an apparatus configured to change the dimensions of the binding element being produced without replacing tooling. This embodiment represents one example of a mechanism that is variable by varying one of the components while connected. The apparatus comprises an arm, or link, 60 which is mounted so that it can rotate around a rotation point 62. The arm 60 has a length that is variable by extending a piston 63 that is received within the arm 60. The piston 63 is mounted such that it can move in the longitudinal direction of the arm 60, by means of a spindle, known in the mechanical arts, located inside the arm 60. A position change of piston 63 can be achieved by means of an electric motor 61, which is mounted on the other end of arm 60, or is located at a fixed location in the housing and transfers its movement by way of a coupling, known in the mechanical arts, to the piston 63.

The piston 63 is mounted on the other end of the bending die rod 46 so that it can rotate relative to the bending die rod 46. By extending the piston 63 in the open position of the wire bending device 40, the first sled 43 is slid in the X direction and in this process, the second sled 43′ is also slid in the X direction, by twice the amount. Because of this, bending die 42″ always stays in the center between the first collet 42 and the second, fixed collet 42′. The loop length L of the wire loop S can thus be varied as a result of the extension or reduction of the part of piston 63 that extends from the arm 60.

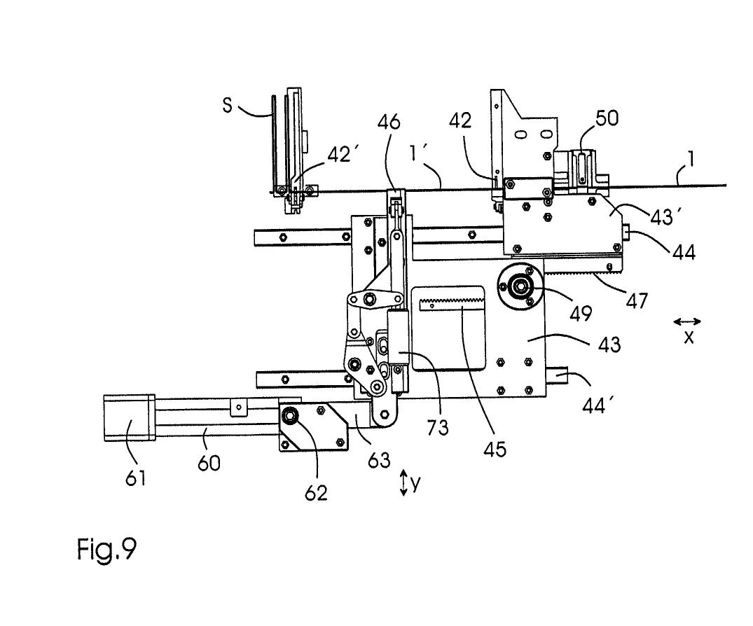

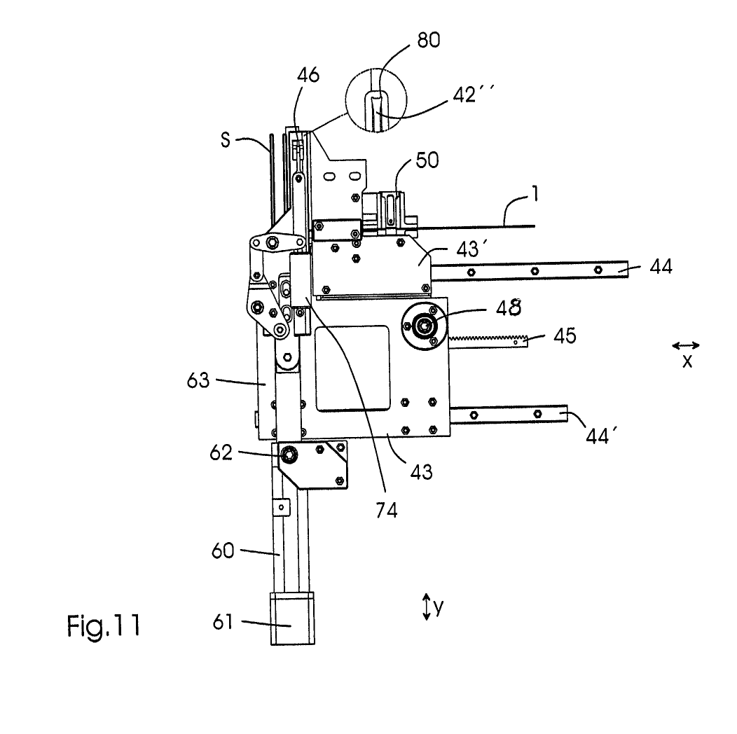

According to a further aspect of the invention, the arm 60 drives the sled 43 and the bending die rod 46. The arm 60 may be driven with a reciprocal rotary motion about the rotation point 62 by a suitable mechanism, such as a cam or a stepper motor, without limitation. As presented in FIGS. 9-11, the wire section 1′ is bent by rotating the arm 60 counterclockwise from the initial position shown in FIG. 9, to a final position shown in FIG. 11. Rotation of the arm 60 causes an attendant rectilinear X motion in the sled 43 and Y motion in the bending die rod 46. A counterclockwise movement of the arm 60 is followed by an equal in magnitude clockwise movement that places the arm 60 back at the initial position. In the embodiment presented, the included angle of movement in each direction is 90°, although other angles are contemplated in the practice of the invention.

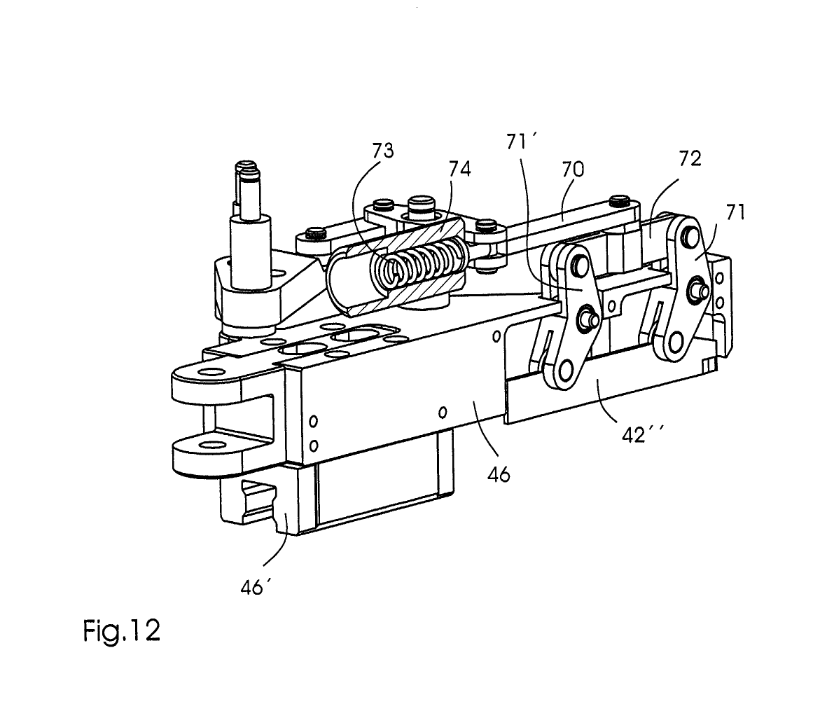

The embodiment of FIGS. 1 and 9-12 is further characterized by the bending die rod 46 having the bending die 42″ mounted in a manner so that it can swivel, which can be seen enlarged in FIG. 12. Bending die 42″ is mounted on two toggles 71, 71′ so that it can swivel. Toggles 71, 71′ are connected by way of a rod 72 in such a way that a forward movement of the rod 72, that is triggered by the spring-mounted rod 70, causes a dipping of the bending die 42″ into the inside of the bending die rod 46. Because of the toggles 71, 71′, the position of the bending die 42″ remains parallel from the swiveled-in condition to the swiveled-out condition. The rod 70 is pretensioned with a spring 73 in order to press the bending die 42″ onto wire 1 with constant force during the wire bending process. This pretension is adjusted by means of a screw (not shown) that is known to the person skilled in the art, which is mounted in spring housing 74 so that it can turn and press against spring 73.

To produce a wire binding element the wire is supplied to the collet 42, 42′ and bending die 42″ and the collets are closed by electromagnets triggered by control electronics or by a cam control of the type known in the mechanical arts, such that the wire 1 is stopped on a section 1′ between the collets 42, 42′.

In the initial piston, the bending die 42″ is mounted exactly in the middle between the two collets 42, 42′ (see FIG. 9), whereby the spacing of the two collets 42, 42′ is always twice the loop length L (see FIG. 2). For the brochure formats to be produced from DIN A3 to DIN A5, these lengths correspond to, i.e. 2×25−80 mm, plus approx. 2 mm as a result of the wire bending radius. As used herein the term “format” is intended to mean the dimensions of the sheet being bound, length and width. Of course, other formats are contemplated in the practice of the invention.

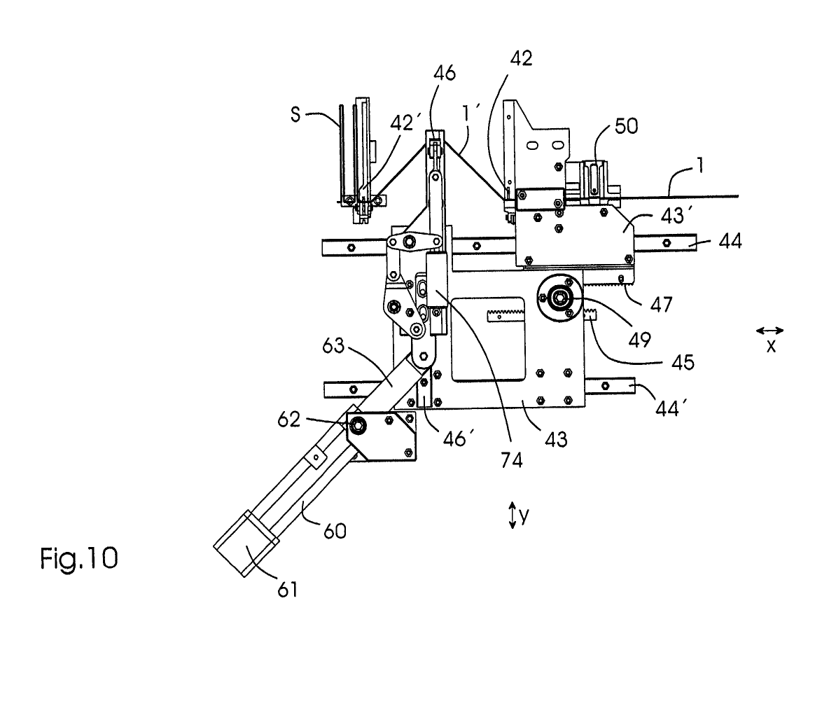

FIG. 10 shows the wire bending device 40 part way through the process of bending a loop in the wire section 1′. Because of a rotary movement of the arm 60, as previously described herein, the bending die rod 46 is slid with a sinusoidal speed profile, along the guide 46′ of bending die rod 46, and the clamped wire piece 1′ is pushed forward. Simultaneously, the sled 43 moves to the left along guides 44, 44′ with a sinusoidal speed profile. As discussed previously, the collet moves twice the distance the sled 43 moves, and both move with complementary sinusoidal displacements, as previously described herein with reference to FIGS. 7 and 8. Still referring to FIG. 10, this movement may also draw wire from a supply roll 21, 22, 23, for the next consecutive loop.

Because of the movement coupling, the bending die 42″ remains exactly in the center between the collets 42, 42′. Because of spring 73, the bending die 42″ is pressed against the wire piece 1′ with constant pressure and the wire is thereby held tight with a constant force between the clamping points of collets 42, 42′.

FIG. 11 shows the device after the bending is completed. As can be seen in the enlargement of the bending die 42″, the bending die 42″ has two tabs 80 on the sides that press the wire 1″ at the bending points, so that springing back after the bending is largely ruled out. The collets 42, 42′ preferably have comparable tabs. In order to prevent the loop shank from springing back, the wire is also pressed with a device known in the mechanical arts.

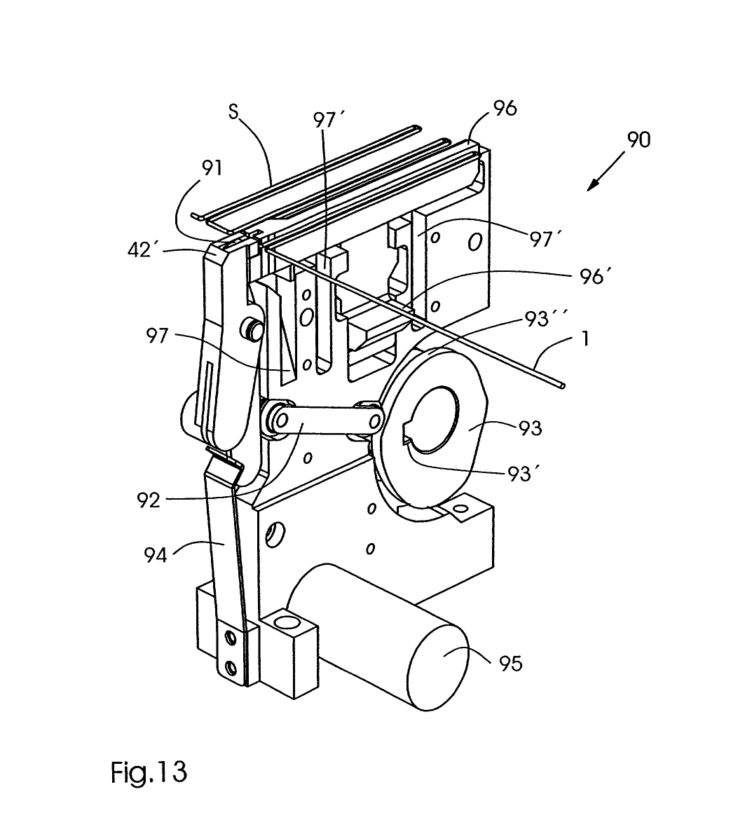

After complete bending of a loop S, the wire is stopped using the feeder collet 50 and then the collets 42, 42″ are opened. By means of the toggles 71 (FIG. 12) and a linkage activated by a suitable apparatus, such as a cam or solenoid, the bending die 42″ is swung out of the loop S upward toward the bending die rod 46. The bending mold 96 (see FIG. 13) of the second, fixed collet 42′ is moved downward so that the feed is free for loop S. After that, the feeder collet 50 moves forward in the wire direction 2 by the loop distance A, the second, fixed collet 42′ again stops the wire 1, the feeder collet 50 opens and the first sled 43 and the second sled 42′ move back into the initial position in order to initiate the production of the next loop S. Before production of the next loop S, the loop length L may be readjusted by means of the piston 63 and thus the loop geometry may be readjusted. Preferably, this new adjustment is carried out during the reverse movement of the arm 60, so that additional loops can be produced without a loss of time.

In another embodiment, the movement is initiated by switching on the sinusoidal-controlled stepper motor 49, but the sequence of the individual movements for bending the wire loop S remain unaffected by this and are according to the sequence described above.

According to the invention, a constant loop spacing A of 12 mm is preferred for all the brochure formats to be produced, DIN A3 to DIN A5 and the US formats corresponding to them

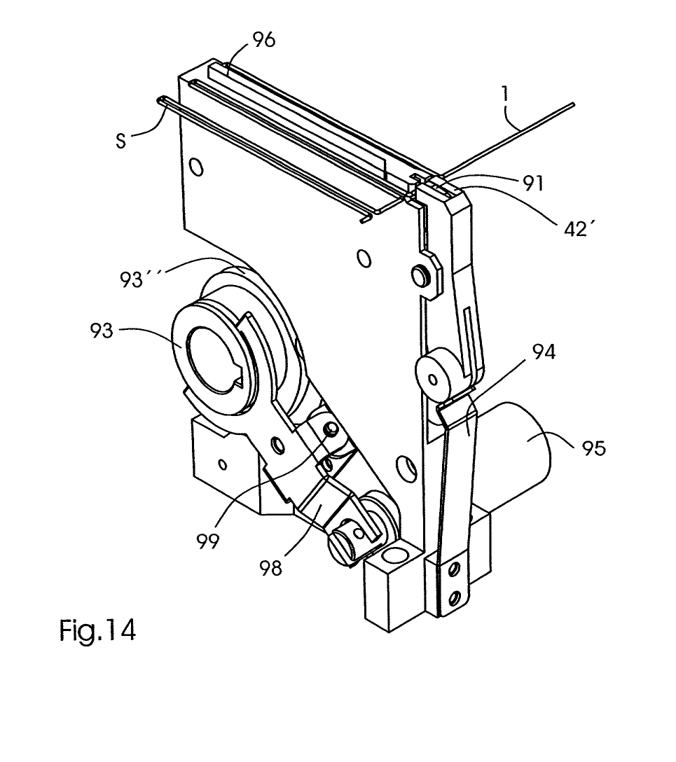

Once the number of loops N specified by the control electronics is reached, corresponding to the largest format to be bound, the wire binding elements 41, 41′, 41″ are cut by means of the wire cutter 90, which is shown in FIGS. 13 and 14.

FIG. 13 shows a side view of the wire cutting device 90 with the collet 42′, whereby the housing cover is left out for illustration purposes. The collet 42′ presses the wire 1 against a mold 96. This mold 96 has a tab 96′. Two springs, (not shown) that are located in the spring shafts 97′ in the housing of the cutting device 90, press the mold 96 with the tab 96′ against a stop that is not shown, which is mounted so that it can be moved, e.g. can be pressed downward against the springs in order to lower the mold 96 in the housing of the cutting device 90. In this way, the mold 96 can be moved out of the way and the loop S is slid after bending of the wire 1′.

Between the jaws of the second, fixed collet 42′, a cutting knife 91 is mounted on a lever and pretensioned with a spring 94. In contact with the cutting knife 91 there is a coupling 92 that is in contact on the other side with a curve surface 93″ on a cam 93 which is mounted so that it can be slid on a shaft that is not shown and is known to the person skilled in the art and has a tab 93′. The shaft is structured with a rib corresponding to tab 93′, so that in this way the cam 93 is also moved.

FIG. 14 shows, next to the curve surface 93″, a toggle 98 engages in the cam 93, which is mounted so that it can rotate around an axle 99. Because of the movement of the toggle around axle 99, the cam 93 can be slid on the shaft that is not shown such that the coupling 92 is in contact or not in contact with curve surface 93″. The toggle 98 is moved by an electromagnet 95, that is actuated by a control unit known in the art.

During the bending process, the cam is in a position in which the coupling 92 is not in contact with the curve surface 93″. The control unit of the electromagnet 95 is not actuated until the required number of loops N has been reached and it then draws up the toggle 98 and thus moves the curved disk 93 in the direction of the wire and thus slides the coupling 92 on the curve surface 93″. Because of the shape of the curve surface 93″, the coupling 92 is moved in the direction of the lever, on which the cutting knife 91 is found. Because of this, the cutting knife 91 cuts out a wire piece essentially corresponding to the width of the cutting knife 91. The wire piece that has been cut falls through a wire waste channel into a container that is not shown in the lower area of the housing of wire binding device 40. Then, the curved disk 93 is slid back into neutral position and thus the coupling 92 is released.

Optionally with the aid of suitable sensors, the control unit can determine the manufacturing parameters of the wire binding element (41, 41′, 41″), such as wire diameter, loop length (L), loop spacing (A) and number of loops (N) of the wire binding elements formed (41, 41′, 41″). The production parameters are preferably predetermined.

A device according to one aspect of the invention comprises a wire binding element that is adapted to the respective format and the respective thickness of the brochure can be produced, especially as required and immediately before the binding process.

The device according to a further aspect of the invention carries out the following steps during the production of the wire web:

supply of a wire from at least one wire supply to a wire bending device,

bending of the wire to a flat, loop-shaped wire binding element, the wire web, as it is called,

cutting and/or trimming the wire binding element by means of a cutting device.

The adjustment of the wire binding element to the required format or the thickness may be carried out immediately before bending of the wire to each individual loop. The parameters, in this process in the shape of the wire binding element, i.e. the wire loops that are parallel and separate from one another, are the loop length L and the loop spacing A and the number of loops in a binding element.

In apparatus according to an aspect of the invention, the loop length and/or the number of loops and/or the loop spacing can be selected as desired.

In another embodiment, the wire binding element is adjusted to the thickness of the brochures in that the loop length of the wire binding element essentially corresponds to the circumference of a corresponding binding element.

In a particularly preferred embodiment, the loop length is determined or specified immediately before the bending of the wire loop, essentially by the distance between the first collet and a second fixed collet, which are fixed immediately before the bending process of the wire. The loop length essentially corresponds to half the distance from the first collet to the second fixed collet.

In another alternative embodiment of the device according to the invention, the wire web is adapted to the length of the brochure, which are to be loosely bound with it, in that the number of loops in the wire web essentially corresponds to the number of perforations in the series of perforations provided along one edge of the sheets of the printed material.

In another alternative embodiment, instead of a single wire binding that runs over the entire width of the brochure using a single wire binding element, a number of wire binding elements, in particular three wire binding elements are used, that can be meshed in the series of perforations at the ends and the center of the wide side of the brochure. The advantage of this is that on one hand, material is saved, and on the other a number of different brochure formats with the same brochure thickness can be bound with the same wire webs.

In another alternative embodiment, a number of wire binding elements are meshed in each case by only one loop in the series of perforations of the brochure to be bound. Here as well, a high binding speed can be achieved by simultaneous meshing of the large number of wire binding elements.

According to one aspect of the invention, the loops of the wire binding element are produced sequentially. After repeated bending of loops and after the required number of loops is obtained in the wire binding element, the wire binding element is cut.

According to a further aspect of the invention, the wire binding element will additionally be adapted to the format of a series of perforations of a brochure, especially in that the loop spacings are shifted, by a corresponding feed of the wire binding element after bending of a loop, far enough so that it essentially corresponds to the hole spacing of the series of perforations provided along one edge of the sheets of the printed material. In this process, spacing between two loops can vary from loop to loop, in that in each case the required feed is carried out accordingly after the bending.

In a particularly preferred embodiment, there is a first sled that holds the means for bending the wire to a wire binding element, and can be moved back and forth along the transport direction of the wire between a fixed collet and a wire supply. The wire is bent by clamping a piece of the wire, whose length essentially corresponds to twice the loop length, between two collets. In this process, the first bending elements are placed on a second sled that is in an operating connection with the first sled, which can be slid and in particular, along a guide that runs parallel to the wire. The operating connection between the first and second sled is such that while the first sled moves along the guide, the second sled covers twice the distance in the same direction as that of the first sled. A bending die that is mounted on the first sled travels exactly half the distance that the first collet travels. If the bending die is mounted essentially in the middle between the collets, it remains essentially in the center between the collets due to the operating connection between the two sleds during each movement along the guide.

According to a further aspect of the invention, the operating connection described above is obtained by at least one pinion that runs on two racks. In this process, the first rack is fastened in a fixed location on the housing. The first pinion, which is fastened on the first sled, engages in the first, fixed rack. A second rack, into which the first pinion also engages, is mounted on the second sled. Optionally, a second pinion to which the rotary movement of the first pinion is transferred by way of a shaft or other coupling mechanism, can also engage in the second rack.

According to a further aspect of the invention a rocker is mounted in a fixed location on the housing of the device, so that it can rotate, and is connected by a first movable linked coupling to the first sled and a second movable linked coupling to the second sled. If the distance between the fixed point of rotation and the mounting point of the first coupling on the rocker is essentially equal to the distance between the mounting points of the two couplings on the rocker, then it is possible to attain a 1:2 ratio of the movement of the first sled to the second sled.

The change between different loop lengths is achieved, according to one aspect of the invention, by the approach of a new collet position with simultaneous, automatic approach of the new center position of the bending die.

According to one embodiment of the invention, during the closing movement of the first collet, the bending die is moved on a circular path essentially in the center between the first collet and the fixed second collet and in this process, the center of the wire piece is pushed outward, between the collets perpendicular to the closing movement. The circular path of the bending die occurs because of a combined movement of the first sled and that of the bending die rod bearing the bending die. In this process, the first sled is guided in x-direction parallel to the direction of the wire feed by a suitable guide known to the person skilled in the art, and the bending die rod in y-direction perpendicular to this by a suitable guide known to the person skilled in the art. In order to achieve the circular path of the bending die, the superimposed movements are carried out with an essentially sinusoidal speed profile.

According to a further aspect of the invention, the first sled is driven in at least one movement component, and especially in both movement components, with an essentially sinusoidal speed profile by stepper motors controlled by means of known electronics.

According to a further aspect of the invention, the circular movement of the bending die rod is carried out by an arm configured to rotate. In this process, in an advantageous manner an arm that has the bending die rod attached to its end is rotated around a fixed point of rotation. The movement that the mounting point of the arm and bending die rod carries out during the rotating movement is thereby automatically circular. The movement of the sled is transferred through the guides in X and Y direction. The sinusoidal speed profile of the movement components also results, in and of itself, if the arm moves at an essentially constant angular speed.

A change in the loop length can be achieved especially simply, quickly and precisely in a further development of the device according to the invention, in that the motor drives a piston that can lengthen or shorten the arm between the point of rotation and the mounting point on the bending die rod. Because of this, in the open state of the wire bending device, the length of the wire to be clamped changes and this determines the loop length of the loops of the wire web.

The variability provided by one aspect of the invention is useful, since for each loop length the different speed profiles have to be otherwise calculated or looked up in a table. In addition, a circular movement of this type, which is possible with a cam control, can never be achieved with a stepper motor.

After reaching the bending end position, the bending die may be raised vertically in order to make a feed of the wire binding element possible. Because of this, deformations and friction can be prevented that would occur when retracting the bending die in the plane of the wire binding element. In addition, a vertical lifting of the bending die requires lower forces and is carried out in a less time.

According to a further aspect of the invention, the wire may be pressed laterally after the bending in the closed state of the bending device, before the bending die is raised in order to permit the feed of the wire binding element. Because of this, the forming of the loop is advantageously supported during the bending process and a springing-back of the bent wire is decreased.

According to a further aspect of the invention, during bending, the bending die may also press against the wire by means of a spring. Because of this, the wire segment to be bent is continuously held tight with an essentially constant spring force during the bending process, which has an advantageous effect on the forming in the bending process.

According to a further aspect of the invention, a cutting device may be mounted immediately after the second, fixed collet. The cutting device is advantageously arranged inside the second, fixed collet. In this process, the cutting device is structured in such a way that it cuts a piece of the wire and this piece falls through the second, fixed collet. Because of this, the wire is held especially tight during the cutting which means that smooth cut edges can be achieved. This is especially advantageous for decreasing the danger of injury.

According to a further aspect of the invention, the selective cutting of the wire after reaching the required number of loops may be implemented in a preferred embodiment of the invention such that the mechanism for carrying out the cutting, in particular a curved disk, which is contacted over a lever to a roller which actuates the cutting knife, is swung in, especially by applying power of an electromagnet.

To further improve the forming of the loops, according to a further aspect of the invention, the bending die and/or at least one of the collets is designed with a tab that presses into the inner radii of the bending locations during bending process. The use of such tabs during wire bending is known from the state of the art.

The process for producing brochures of different formats and thickness using wire comb binding offers several advantages. A fully automatic production of wire binding elements is possible for binding brochures with any loop length L, width A and preferably wire diameter D with a number of loops corresponding to the maximum brochure length that can be processed. A reconfiguration or adaptation of the device for producing the wire binding elements is not necessary. Deformations in the wire binding elements that are produced especially on demand are prevented by the automatic production and the possibility of a very short transport path of the wire binding element up to a device for further processing of the wire binding element, so that the susceptibility to interference is drastically reduced compared to conventional devices. In particular, this makes it possible to cost-effectively, flexibly and quickly produce wire binding elements for brochures, especially for personalized brochures or books with very small print runs, in extreme cases for a print run of one copy.

In this process, the parameters for the loop spacings and length may be determined by the device according to the invention using a sensor that determines the format and thickness and if necessary the type of perforations of the brochures to be bound and transfers them to the control unit and/or the parameters are transferred to the control unit from preceding devices or by the user.

In a second step, the manufacturing parameters for the wire binding element may be specified by the control unit and in a third step, the wire binding element is produced by means of devices that are electronically and mechanically connected to each other.

An example of binding system that implements the apparatus and processes of the present invention is disclosed in a U.S. patent application Ser. No. x/xxx,xxx filed on even date herewith, entitled BINDING PROCESS FOR MANUFACTURING BROCHURES, naming Blattner et al. as inventors. A suitable closing device is disclosed in U.S. patent application Ser. No. x/xxx,xxx filed on even date herewith, entitled APPARATUS AND METHOD FOR SEGMENTED BENDING OF WIRE BINDING ELEMENTS, naming Hans-Peter Wurschum as inventor. The contents of both of these applications are hereby incorporated by reference, as if set forth herein. In referencing these applications, it is not intended to limit the invention to the specific embodiments disclosed, since it is evident that numerous variations and additional embodiments are possible.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

What is claimed is:

1. A process for producing wire binding elements for binding brochures, comprising:
forming a loop in a wire with a mechanism comprising a set of connected components, and varying a dimension of said loop for at least one of said brochures by varying at least one of said components while connected.

2. The process of claim 1, further comprising rotating at least one of said components.

3. The process of claim 1, further comprising moving at least one of said components rectilinearly.

4. The process of claim 1, further comprising forming said loop by moving two of said components rectilinearly transverse to each other.

5. The process of claim 1, further comprising forming said loop by moving a bending die in an arc generated by moving two of said components rectilinearly transverse to each other.

6. The process of claim 1, further comprising determining a loop length to form.

7. The process of claim 1, further comprising determining a number of loops to form.

8. The process of claim 1, further comprising determining a loop length to form based on a thickness of at least one of said brochures.

9. The process of claim 1, further comprising determining a loop length immediately before forming said loop.

10. The process of claim 1, further comprising forming a number of connected loops corresponding to a number of perforations along an edge of at least one of said brochures.

11. The process of claim 1, further comprising forming several loops corresponding to perforations along an edge of at least one of said brochures.

12. The process of claim 1, further comprising cutting said wire after a determined number of connected loops are formed.

13. A process for producing wire binding elements for binding brochures, comprising:
forming a loop in a wire with a mechanism comprising a set of connected components, and varying a dimension of said loop for at least one of said brochures by varying said mechanism with at least one of said connected components.

14. The process of claim 13, further comprising rotating at least one of said components.

15. The process of claim 13, further comprising moving at least one of said components rectilinearly.

16. The process of claim 13, further comprising forming said loop by moving two of said components rectilinearly transverse to each other.

17. The process of claim 13, further comprising forming said loop by moving a bending die in an arc generated by moving two of said components rectilinearly transverse to each other.

18. The process of claim 13, further comprising determining a loop length to form.

19. The process of claim 13, further comprising determining a number of loops to form.

20. The process of claim 13, further comprising determining a loop length to form based on a thickness of at least one of said brochures.

21. The process of claim 13, further comprising determining a loop length immediately before forming said loop.

22. The process of claim 13, further comprising forming a number of connected loops corresponding to a number of perforations along an edge of at least one of said brochures.

23. The process of claim 13, further comprising forming several loops corresponding to perforations along an edge of at least one of said brochures.

24. The process of claim 13, further comprising cutting said wire after a determined number of connected loops are formed.

25. An apparatus for producing wire binding elements for binding brochures, comprising:
a wire loop forming mechanism having a set of connected components, at least one of said components being variable while connected to determine a dimension of said loop for at least one of said brochures.

26. The apparatus of claim 25, further comprising a first collet and a second collet, and a loop length corresponds to half a distance from said first collet to said second collet.

27. The apparatus of claim 25, wherein said mechanism is configured to form a plurality of connected loops.

28. The apparatus of claim 25, further comprising a wire cutter.

29. The apparatus of claim 25, wherein one of said components comprises a wire bending die, and wherein said mechanism is configured to move said bending die in arc.

30. The apparatus of claim 25, wherein said components include an arm having a variable length and configured to rotate.

31. An apparatus for producing wire binding elements for binding brochures, comprising:
a wire loop forming mechanism having a set of connected components, at least one of said components being variable while connected to determine a dimension of said loop for at least one of said brochures,
said components including a first sled moveable in a first direction, and a bending die mounted on said first sled moveable in a second direction transverse to said first direction.

32. The apparatus of claim 31, wherein said components include an arm configured to rotate and having a variable length connected to said bending die.

33. The apparatus of claim 31, wherein said components include a second sled configured to move in said first direction twice as far as said first sled.

34. The apparatus of claim 33, wherein said first sled and said second sled are interconnected by a pinion.

35. The apparatus of claim 33, wherein said first sled and said second sled are interconnected by a rocker.

36. The apparatus of claim 31, wherein movement of said first sled and said bending die are interrelated to move said bending die in an arc.
